(19) United States
(12) Patent Application Publication
(10) Pub. No.: US 2022/0129542 A1
(43) Pub. Date: Apr. 28, 2022

(54) DETERMINISTIC TRUSTED EXECUTION CONTAINER THROUGH MANAGED RUNTIME LANGUAGE METADATA

(71) Applicant: Intel Corporation, Santa Clara, CA (US)

(72) Inventors: Mingqiu SUN, Beaverton, OR (US); Lin ZANG, Beijing (CN)

(73) Assignee: Intel Corporation, Santa Clara, CA (US)

(21) Appl. No.: 17/428,778

(22) PCT Filed: Mar. 5, 2019
(86) PCT No.: PCT/US2019/020672

§ 371 Date: Aug. 5, 2021

(51) Int. Cl. G06F 21/53; G06F 21/54; G06F 21/74; G06F 21/60

(52) U.S. Cl. CPC G06F 21/53; G06F 21/602; G06F 21/74; G06F 21/54

(57) ABSTRACT

Various embodiments are generally directed to an apparatus, system, and other techniques for executing program code, such as managed runtime language, entirely in a hardware trusted execution environment (TEE) while enforcing and abiding by security requirements. Components in the TEE may receive the program, which may include metadata, perform analysis on the metadata, determine whether any API should be disabled from accessing untrusted resources, and execute an exception if the API attempts to access an untrusted resource. One or more security domains may be used in the TEE along with respective protection keys to enhance and maintain security.

### TECHNICAL FIELD

Embodiments described herein generally relate to techniques for enforcing security in hardware trusted execution environments.

### BACKGROUND

In a hardware trusted execution environment (TEE), selected code or data may be protected from disclosure or modification in allocated private regions of memory. Software developers may use TEEs to develop products that have certain trusted execution requirements.

Runtime programming languages, such as Java, JavaScript, C#, Python, etc., may be widely used for developing various applications. For security reasons, however, none of these languages are fully supported in or by the TEE. Typically, TEE programming models require developers to refractor code to exploit the security features of the TEE, which can be difficult for complicated software or code bases that have numerous dependencies on legacy or third-party codes.

One known solution involves providing “library OS,” which may involve the entire operating system running in the form of libraries. These libraries, however, access or make calls to untrusted resources outside of the TEE. Thus, this solution can introduce security vulnerabilities to the applications running in the TEE without the developer's knowledge and expose applications to security risks, such as side channel attacks.

### BRIEF DESCRIPTION OF THE DRAWINGS

FIG. 1 illustrates an example managed runtime system.

FIG. 2 illustrates an example security domain configuration.

FIG. 3 illustrates an example communication mechanism between security domains.

FIG. 4 illustrates an example an example message handling in a security enforcer.

FIG. 5 illustrates an example computing architecture.

FIG. 6 illustrates an example system.

FIG. 7 illustrates an example flow diagram.

### DETAILED DESCRIPTION

Various embodiments are generally directed to a managed runtime system in a hardware trusted execution environment (TEE) configured to run software, program, code, etc. while maintaining and enforcing the security of the environment. For example, a developer may specify and control the security behaviors of the application program running in the TEE based on at least a language mechanism provided in the managed runtime system. Based on the security specification of various components of an application, the managed runtime system may enforce the security requirements or expectations via site isolation mechanisms using security-based technologies, such as protection keys. Accordingly, the managed runtime system may run an application in the TEE without compromising the secure environment. Moreover, the system may also support native programming languages, such as C/C++ or the like.

In embodiments, the managed runtime system provides a mechanism in which a developer may be made aware and ultimately control the security-related behavior of software. The managed runtime system may accept unmodified software along with metadata that may be included, for example, in the configuration file and/or embedded in the software itself. For instance, the metadata may be written by the developer to indicate to the managed runtime system whether certain trusted or untrusted features associated with running the program (e.g., classes, functions, etc.) can be accessed when the program is running. The system performs analysis on the metadata and enables or disables resource accessibility. In one example, the managed runtime system may provide a profiling mode to dump all untrusted resources when the program runs to make the developer aware what untrusted resources the program will access and the overall untrusted-related behavior of the program to allow the developer to implement configuration policies, for example, when developing configuration files.

According to examples, the managed runtime system may include a number of features or components that are uniquely configured to run software without compromising the security of the TEE. For example, one or more TEE-based libraries may support the managed runtime of the system in the TEE or a portion thereof. The libraries may provide one or more application programming interfaces (APIs) access to various untrusted resources, such as network input/output (I/O), file systems, system calls, etc. The managed runtime may also include an API wrapper configured to enable or disable the accessibility of resources. In another example, the managed runtime system may include a metadata parser configured to parse metadata in a configuration file and/or metadata that may be embedded in the program itself in the form of annotation(s). The metadata may be written by the developer. In yet another example, the managed runtime system may include a security enforcer that reads configuration data from the parser and instructs the system (or components thereof) to disable or enable the accessibility to various resources accordingly. The security enforcer may also allocate system resources, such as heap, method tables, or the like, with at least a protection key based on or according to user-defined security requirements. In a further example, the system may also include a “dumper” to “dump” one or more APIs (e.g., untrusted APIs, any component that may be exposed to potential threats) invoked by the program at runtime, where the dumped data can help the developer to produce configuration files. In yet a further example, the managed runtime system may output an exception message or other suitable exception handlers to properly process the unauthorized access at runtime.

It may be understood that the hardware trusted execution environment may be, for example, Software Guard Extensions (SGX) technology by Intel® Corporation, which may be a set of central processing unit (CPU) instruction codes that allow user-level code to allocate private or secure regions of memory protected from processes running at higher privilege levels. These allocated private or secure regions of memory may be referred to as “enclaves” or “containers.” Other suitable types of trusted execution environments may also be used. As a specific example, a secure region of memory can be defined, where the contents of the secure region are accessed (e.g., from read, copy, save, etc.) by any process outside the region itself, including processes running at higher privilege levels, is restricted. The secure region can be formed by processing circuitry encrypting the region of memory, and then only decrypting the region for code and data running from within the region itself.

As described above, at least one problem in the previous solution is that operating system libraries running inside the TEE access or make calls to untrusted resources outside of the trusted environment, which introduces security vulnerabilities to the applications in the TEE. Additionally, the developer may not know specifically what parts of the software running outside of the trusted environment at runtime are exposed to the security vulnerabilities. The embodiments and examples described herein overcome these problems. By configuring a managed runtime system to control the enabling or disabling of APIs that can access the untrusted resources and providing the developer with information about the behavior of the program interacting with the untrusted resources, the security of the TEE, such as SGX, can be maintained or enforced while being able to run the runtime-based software. Moreover, the managed runtime system may enforce security requirements via additional security features, such as the implementation of protection keys. Accordingly, accessing resources outside of the TEE can be controlled by the system and/or the developer, and thus, allows the TEE to remain secure and the execution therein deterministic.

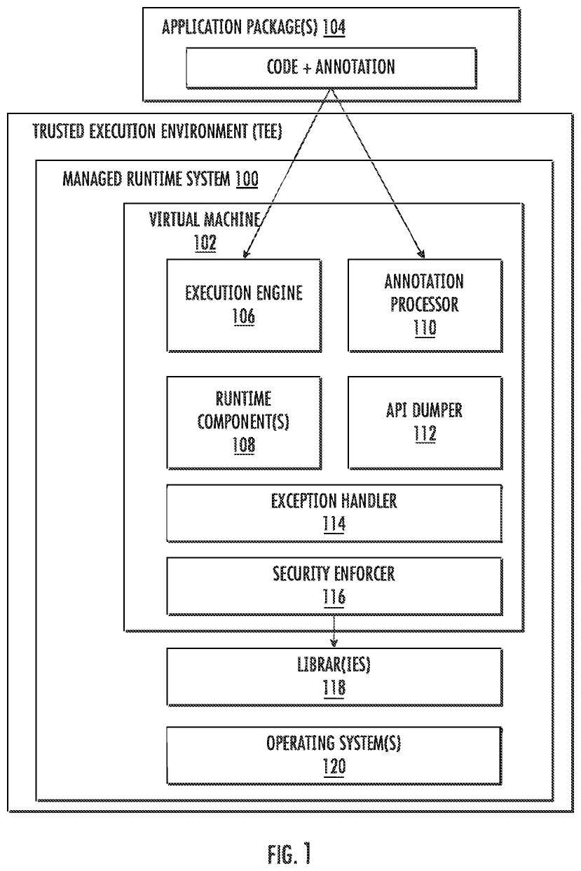

FIG. 1 illustrates an example of a managed runtime system 100 according to embodiments of the disclosure. The managed runtime system 100 and the various components thereof may be arranged in, be a part of, and/or run or be executed in a trusted execution environment (TEE), e.g., SGX enclave, thereby creating a secure environment. As shown, the managed runtime system 100 may include at least a language-based (e.g., Java) virtual machine (VM) 102 configured to at least accept and run one or more application packages 104. The virtual machine 102 includes at least an execution engine 106, one or more runtime components 108, an annotation processor 110 (e.g., metadata parser, configuration file parser), an API dumper 112, an exception handler 114, and a security enforcer 116. It may be understood that the virtual machine 102 and the components therein, which are software-based features, may be supported or executed by one or more processing units (e.g., processors, central processing units, field programmable gate arrays, etc.), as will be further described below.

In examples, metadata related to security requirements may be written in a configuration file. As illustrated, the virtual machine 102 may receive the one or more application packages 104, which may be a program or portions of a program written in a specific runtime language and may contain a configuration file that indicates which APIs will be disabled or enabled (e.g., by way of determining which APIs are not disabled). The annotation processor 110 may receive, for instance, the configuration file, analyze the file, and instruct the one or more runtime components 108 (or other suitable components) which APIs need to be disabled or enabled. In some examples, the configuration file may also indicate to enable API dumping, where the API dumper 112 may dump one or more APIs (e.g., invoked APIs to untrusted resources, etc.) when the program is running. At runtime, for example, the security enforcer 116 may verify whether an API has been disabled when that API is invoked. If the invoked API was disabled by the configuration file, the exception handler 114 may throw and handle an exception (e.g., print an error message and abort runtime based on the security trigger), such as a “DenyOfUnsecureAccess” exception, which may then be executed. If the invoked API was indeed enabled, e.g., the invoked API was not disable, the API may be accessed. It may be understood that the verification of the disabling may be performed prior to executing the exception.

The format of the one or more configuration files 104 may be any kind of format that can be parsed by the annotation processor 110, which may be, for instance, a configuration file parser. The configuration file parser may set one or more switches defined in the runtime to enable or disable APIs to access untrusted resources. In one example, the configuration file may be in “xml” format, which may contain annotations related to dumping, enabling, and/or disabling certain APIs, for instance, disabling network-related APIs and enabling certain file-related APIs). After the xml configuration file is parsed by the configuration file parser, the virtual machine 102 may disable certain APIs (e.g., Network I/O) and not disable, or enable, others (e.g., file I/O) via the security enforcer 116, while the API dumper 112 may dump one or more invoked APIs to untrusted resources. As described above, the dumping feature of the API dumper 112 allows the developer to “catalog” all the untrusted resources the program will or may access and the overall untrusted-related behavior of the program such that the developer can study these behaviors to implement configuration policies, for example, when developing configuration files.

In other examples, the metadata defining the security requirements may be included in the program or source code of the program itself, such as Java annotation. In a Java-based example, the metadata may be embedded in to the program or source code, e.g., in the form of annotation. The Java compiler, for example, may embed the annotation into the “.class” files. Developers may use predefined annotations or create their own annotations to define security requirements in the code. The embedded annotations may be generated as metadata or information stored in the class file by the Java compiler. The annotation processor 110 may then analyze the class file and instruct the one or more runtime components 108 to allow the virtual machine 102 to enable or disable (and/or dump) certain APIs. By way of example, when the virtual machine 102 analyzes the class file at the class loading phase, it may set one or more flags for every class and method based on the metadata. These flags may be used by the security enforcer 116 to enable or disable the APIs at runtime.

According to embodiments, the security enforcer 116 may define one or more switches configured for enabling or disabling one or more APIs that access untrusted resources. The security enforcer 116 may also implement all wrapper functions of the APIs for accessing the untrusted resources. Moreover, the security enforcer 116 may implement a mechanism to define one or more security domains in the TEE and conduct security isolations among the one or more domains. In examples, the security enforcer 116 may access, interface (programmatically or otherwise) or communicate with one or more TEE-based libraries 118 and/or one or more TEE-based operating systems 120 to provide the APIs for accessing the untrusted resources, creating and managing the switches for enabling or disabling access, implement wrapper functions of the APIs, create and define security domains, etc. As will be further described below, based on domain information provided by the metadata, the security enforcer 116 may invoke native APIs to create and/or destroy the security domains, create necessary resources in runtime for the security domains, such as a secure heap, method tables, etc., and attach a protection key to the one or more domains. Moreover, the security enforcer may be configured to switch between the different domains based at least in part on program execution flow, and further, utilize sandbox messaging to transfer messages between the domains.

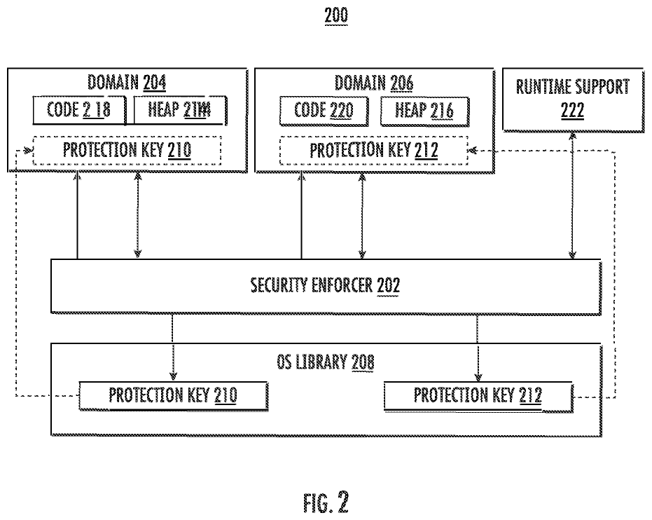

FIG. 2 illustrates an example security domain configuration 200 according to embodiments of the disclosure. Security domains may be defined by a managed runtime system in a TEE so that different parts of a program or software can run in different domains based on various security requirements and/or security scope, e.g., a single security domain such as an SGX enclave, sub-security domains within a single security domain. APIs may be disabled or enabled separately within each security domain and/or sub-domain. For instance, one security domain, which may be a “sandbox” environment, may configured to enable access to a network I/O, while a second security domain may disable access to the network I/O.

As shown in FIG. 2, metadata that has been processed by an annotation processor, e.g., parser, may instruct a security enforcer 202 to create one or more security domains, e.g., security domains 204 and 206. The security enforcer 202 may then communicate or interface with an operating system library 208 (e.g., located in the TEE) to generate one or more protection keys, e.g., protection keys 210 and 212, which may be attached to the security domains 204 and 206, respectively, as shown by the dashed arrows and boxes. It may be understood that a protection key may be any feature configured to protect and secure the content in the security domain, e.g., made up of a specific length of bits, and may be generated and attached or bound to a security domain such that only that protection key is associated with the security domain and can unlock access to its content. It may also be understood that, in some examples, codes may be shared among different security domains, or in other examples, all code (or part of the code segment associated with executing threads) may be put in a single special, thread-specific security domain, which may be used to protect data.

Based on the processed metadata, the security enforcer 202 may enable or disable API accessibility to outside resources, and further create related resources for each security domain, such as managed heap (e.g., heaps 214, 216), native memory for class metadata, managed program stack, programs, code (e.g., code 218, 220), etc. In examples, at runtime, when a violation occurs, such as codes (e.g., codes in a thread) in the security domain attempting to access disabled resources, a DenyOfUnsecureAccess exception may be output, as described above. When the program in the managed runtime system has been executed and ends, the runtime support 222 (or any component of the manage runtime system) may require the security enforcer 202 to destroy the security domains 204 and 206 and release the protection keys 210 and 212.

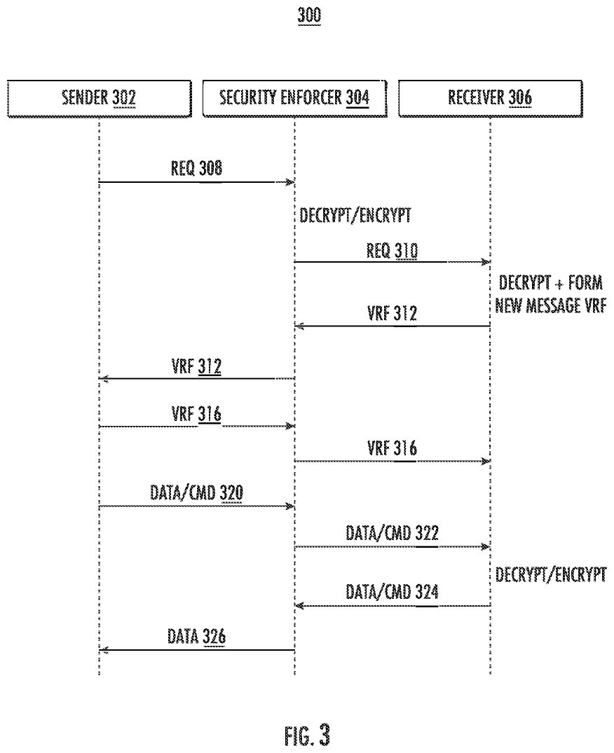

FIG. 3 illustrates an example communication mechanism 300 between security domains according to embodiments. In embodiments, to establish communication between code of a first security domain and code of a second security domain, the first security domain may send a request to a security enforcer. For example, the security enforcer may establish a communication tunnel for the security domains and dispatch one or more messages thereto. The security enforcer may also create and/or destroy message queues. Messages in the message queues may be encrypted by the protection key of the “sender” security domain, where it will be decrypted by the security enforcer, and then encrypted by the security enforcer with the protection key of the “receiver” security domain. Since at least the security enforcer runs in a trusted execution environment, such as in an enclave of SGX, safe and secure communication of the messages may advantageously be ensured.

As illustrated, the communication mechanism 300 includes at least three interacting components, e.g., a sender 302 (such as a sender security domain), the security enforcer 304, and a receiver 306 (such as a receiver security domain). The sender 302 may send a message to the security enforcer 304. The message may include at least four different blocks that contain specific types of information. For example, the message may include a “SND” block, a “REV” block, a “TYPE” block, and a “PAYLOAD” block. The SND block may indicate the identification of the sender 302, the REV block may indicate the identification of the receiver 306, the TYPE block may include a value identifying the type of message (e.g., “REQ” for connection request, “VRF” for connection verification, “DATA” for data message, “CMD” for command message), and the PAYLOAD block may be the body of the message (which be encrypted by the sending security domain using a protection key). The TYPE block of the message sent by the sender 302 may be set to REQ 308. Moreover, the payload may be encrypted via the protection key of the sender 302.

The security enforcer 304 may receive and enqueue the message into a message queue. The security enforcer 304 dequeues one message from the queue, identifies the identity of the receiver based on the information contained in the REV block, decrypts the payload of the message using the protection key of the sender 302, encrypts the payload using the protection key of the receiver 306, and sends the message with the TYPE block set to REQ 310. The receiver 306 then receives the message, decrypts the payload, checks the type of message, and if the message is a REQ type, the receiver 306 creates a new message and sets its type to VRF 312. The receiver 306 sends the new message to the sender 302 via the security enforcer 304, as shown.

The sender 302 may then receive the message, checks the type of message and payload, and if legal, the sender 302 may send a VRF message 316 to the receiver 306 via the security enforcer 304, where a flag is set to indicate that communication or connection between the sender 302 and the receiver 306 has been successfully established. The receiver 306 receives the VRF message 316, checks the type of message and payload, and if legal, a related flag is set to indicate that the communication or connection between the sender 302 and receiver 306 has been successfully established. As will be further described below, the transfer of data and/or command messages (DATA/CMD), e.g., DATA/CMD 320, 322, 324, and 326 may be similarly configured to the REQ/VRF exchange set forth above.

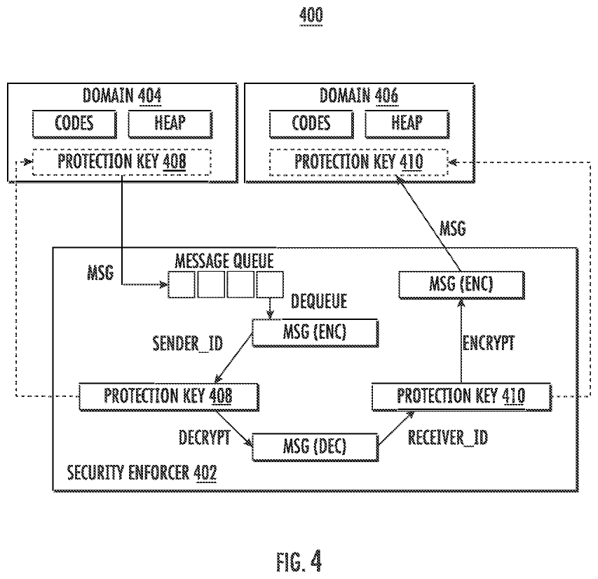

FIG. 4 illustrates an example message handling 400 in a security enforcer 402 according to embodiments. As shown, one or more messages (e.g., “Msg”) may be sent from security domain 404 to security domain 406, which may be handled by the security enforcer 402. All messages sent by the security domain 404 may be encrypted using protection key 408. In the security enforcer 402, each message sent by the security domain 404 may be added to a message queue. The security enforcer 402 may then deque a message from the message queue and determine the identity of the sender, e.g., “Sender_id,” which may be included in the “SND” block of the message. The identity of the sender may allow the security enforcer 402 to identify and use the appropriate protection key, e.g., protection key 408, to decrypt the message.

When the message has been decrypted, the identity of the receiver, e.g., “Receiver_id” may be determined, which may be included in the “REV” block of the message. Similar to identifying the protection key associated with the sender, the security enforcer 402 may identify and use the appropriate protection key, e.g., protection key 410, that is associated with the identity of the receiver to encrypt the message. The security enforcer 402 then encrypts the message and sends it to the security domain 406.

It may be understood that the message handling 400 and the various processes involved therein may all be performed in a trusted execution environment, and thus, remain secure.

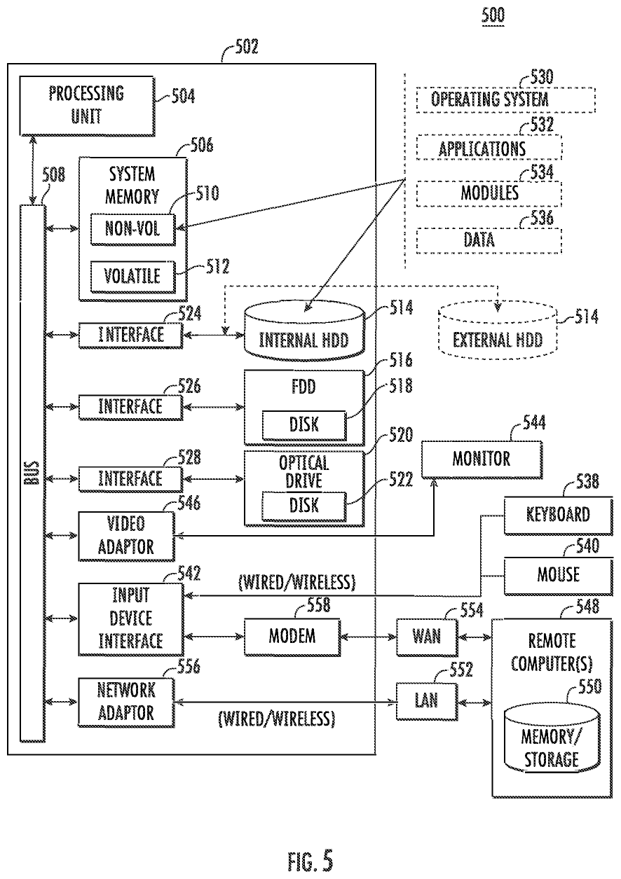

FIG. 5 illustrates an example computing architecture 500, e.g., of a computing device, such as a computer, laptop, tablet computer, mobile computer, smartphone, etc., suitable for implementing various embodiments as previously described. In examples, one or more computing devices and the processing circuitries thereof may be configured as components of the above-described hardware trusted execution environment, e.g., the managed runtime system, the virtual machine, the security enforcer, etc. Moreover, the one or more computing devices may include run SGX and include SGX enclaves.

As used in this application, the terms “system” and “component” are intended to refer to a computer-related entity, either hardware, a combination of hardware and software, software, or software in execution, examples of which are provided by the exemplary computing architecture 500. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 500 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 500.

As shown in this figure, the computing architecture 500 includes a processing unit 504, a system memory 506 and a system bus 508. The processing unit 504 can be any of various commercially available processors.

The system bus 508 provides an interface for system components including, but not limited to, the system memory 506 to the processing unit 504. The system bus 508 can be any of several types of bus structure that may further interconnect to a memory bus (with or without a memory controller), a peripheral bus, and a local bus using any of a variety of commercially available bus architectures. Interface adapters may connect to the system bus 508 via slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 500 may include or implement various articles of manufacture. An article of manufacture may include a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 506 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in this figure, the system memory 506 can include non-volatile memory 510 and/or volatile memory 512. A basic input/output system (BIOS) can be stored in the non-volatile memory 510.

The computer 502 may include various types of computer-readable storage media in the form of one or more lower speed memory units, including an internal (or external) hard disk drive (HDD) 514, a magnetic floppy disk drive (FDD) 516 to read from or write to a removable magnetic disk 518, and an optical disk drive 520 to read from or write to a removable optical disk 522 (e.g., a CD-ROM or DVD). The HDD 514, FDD 516 and optical disk drive 520 can be connected to the system bus 508 by a HDD interface 524, an FDD interface 526 and an optical drive interface 528, respectively. The HDD interface 524 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 510, 512, including an operating system 530, one or more application programs 532, other program modules 534, and program data 536. In one embodiment, the one or more application programs 532, other program modules 534, and program data 536 can include, for example, the various applications and/or components of the system 700.

A user can enter commands and information into the computer 502 through one or more wire/wireless input devices, for example, a keyboard 538 and a pointing device, such as a mouse 540. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, track pads, sensors, styluses, and the like. These and other input devices are often connected to the processing unit 504 through an input device interface 542 that is coupled to the system bus 508, but can be connected by other interfaces such as a parallel port, IEEE 1394 serial port, a game port, a USB port, an IR interface, and so forth.

A monitor 544 or other type of display device is also connected to the system bus 508 via an interface, such as a video adaptor 546. The monitor 544 may be internal or external to the computer 502. In addition to the monitor 544, a computer typically includes other peripheral output devices, such as speakers, printers, and so forth.

The computer 502 may operate in a networked environment using logical connections via wire and/or wireless communications to one or more remote computers, such as a remote computer 548. The remote computer 548 can be a workstation, a server computer, a router, a personal computer, portable computer, microprocessor-based entertainment appliance, a peer device or other common network node, and typically includes many or all the elements described relative to the computer 502, although, for purposes of brevity, only a memory/storage device 550 is illustrated. The logical connections depicted include wire/wireless connectivity to a local area network (LAN) 552 and/or larger networks, for example, a wide area network (WAN) 554. Such LAN and WAN networking environments are commonplace in offices and companies, and facilitate enterprise-wide computer networks, such as intranets, all of which may connect to a global communications network, for example, the Internet.

When used in a LAN networking environment, the computer 502 is connected to the LAN 552 through a wire and/or wireless communication network interface or adaptor 556. The adaptor 556 can facilitate wire and/or wireless communications to the LAN 552, which may also include a wireless access point disposed thereon for communicating with the wireless functionality of the adaptor 556.

When used in a WAN networking environment, the computer 502 can include a modem 558, or is connected to a communications server on the WAN 554, or has other means for establishing communications over the WAN 554, such as by way of the Internet. The modem 558, which can be internal or external and a wire and/or wireless device, connects to the system bus 508 via the input device interface 542. In a networked environment, program modules depicted relative to the computer 502, or portions thereof, can be stored in the remote memory/storage device 550. It will be appreciated that the network connections shown are exemplary and other means of establishing a communications link between the computers can be used.

The computer 502 is operable to communicate with wire and wireless devices or entities using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

The various elements of computing device may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

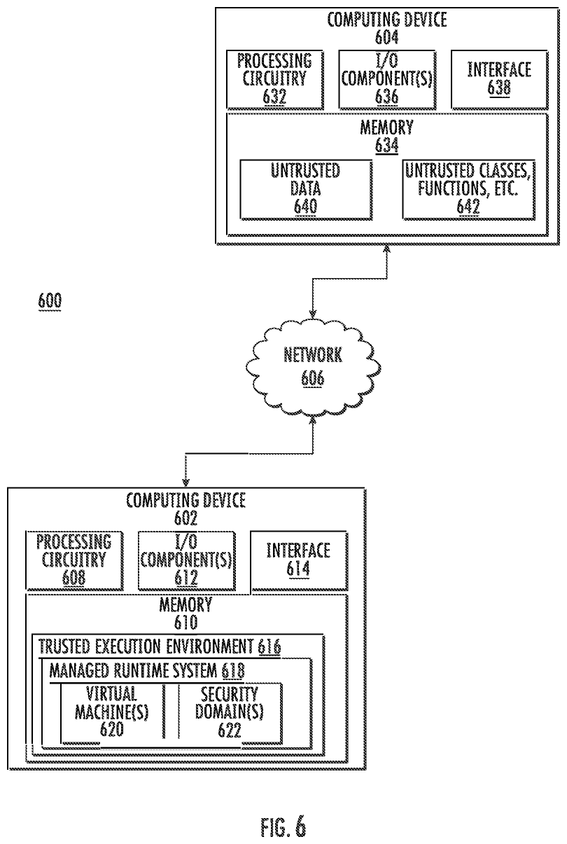

FIG. 6 illustrates an example system 600 according to embodiments. As shown, system 600 includes computing devices 602 and 604 connected to each other via network 606. Network 606 could be, for example, a local area network (LAN), a wide area network (WAN), or a cellular network (e.g., LTE, 3GPP, or the like). In some embodiments, network 606 could include the Internet. While a single computing device 602 and 604 is shown, it may be understood that many more computing devices may be connected to each other via the network 606.

In examples, the computing device 602 may include, at least in part, processing circuitry (e.g., a processor) 608, a memory 610, I/O component(s) 612, and an interface 614. As illustrated, memory 610 may include a trusted execution environment 616, which may include a managed runtime system 618 and one or more virtual machines 620 and one or more security domains 622 therein. Memory 610 may also store one or more instructions for executing specific functions, for example, instructions for performing secure execution of a runtime-based program in the trusted execution environment 616, performing various functions on the virtual machine(s) 620, creating and facilitating communication between the security domains 622, etc. The instructions may also include and correspond to a web browser application used to access a website or a mobile application used to access a mobile application. The trusted execution environment 616 may be or may be located in a secure memory portion. Any of the components in memory 610 may be executable or executed by the processing circuitry 608. All other information stored in memory 610 may also be accessible by or provided to the processing circuitry 608.

Similar to the computing device 602, in examples, the computing device 604 may include processing circuitry (e.g., a processor) 632, a memory 634, I/O components 636, and an interface 638. As shown, memory 634 may store various data or information, such as various instructions, untrusted data 640, and information or data related to untrusted classes, functions, etc. 642. The instructions, for example, may include instructions or executable code for the computing device 604 (via the processing circuitry 632) to communicate with the computing device 602 over network 606 and provide the computing device 602 access to the untrusted data and/or the untrusted classes, functions, etc. 642. The instructions may be executable or executed by the processing circuitry 632. Moreover, all other information stored in memory 634 may also be accessible by or provided to the processing circuitry 632.

According to examples, the processing circuitries 608 and/or 632 may include circuitry or processor logic, such as, for example, any of a variety of commercial processors. In some examples, they may include multiple processors, a multi-threaded processor, a multi-core processor (whether the multiple cores coexist on the same or separate dies), and/or a multi-processor architecture of some other variety by which multiple physically separate processors are in some way linked. Additionally, in some examples, the processing circuitries 608 and/or 632 may include graphics processing portions and may include dedicated memory, multiple-threaded processing and/or some other parallel processing capability.

The memories 610 and/or 634 may include logic, a portion of which includes arrays of integrated circuits, forming non-volatile memory to persistently store data or a combination of non-volatile memory and volatile memory. It is to be appreciated, that the memories 610 and/or 634 may be based on any of a variety of technologies. In particular, the arrays of integrated circuits included in the memories may be arranged to form one or more types of memory, such as, for example, dynamic random access memory (DRAM), NAND memory, NOR memory, or the like.

The I/O component(s) 612 and/or 636 may include one or more components to provide input to or to provide output from the client computing device 602 and/or the validator computing device 604. For example, the I/O component(s) 612 and/or 636 may be a keyboard (hardware, virtual, etc.), mouse, joystick, microphone, track pad, button, touch layers of a display, haptic feedback device, camera, microphone, speaker, or the like.

Interfaces 614 and/or 638 may include logic and/or features to support a communication interface. For example, they may include one or more interfaces that operate according to various communication protocols or standards to communicate over direct or network communication links. Direct communications may occur via use of communication protocols or standards described in one or more industry standards (including progenies and variants). For example, the interfaces 614 and/or 638 may facilitate communication over a bus, such as, for example, peripheral component interconnect express (PCIe), non-volatile memory express (NVMe), universal serial bus (USB), system management bus (SMBus), SAS (e.g., serial attached small computer system interface (SCSI)) interfaces, serial AT attachment (SATA) interfaces, or the like.

As described above, during operation, the computing device 602 may execute a runtime-based program code, software, or the like entirely in the trusted execution environment 616 without the code being refracted, broken, separated, etc. Based on metadata provided in the program, the computing device 602 may determine which of the untrusted data 640 and/or untrusted classes, function, etc. 642 can be accessed by disabling or enabling APIs that can access those resources in the computing device 602. Moreover, the computing device 602 may configure the security domain(s) 622 to perform the above described functions, and further, allow the security domains to communicate with each other via a security enforcer.

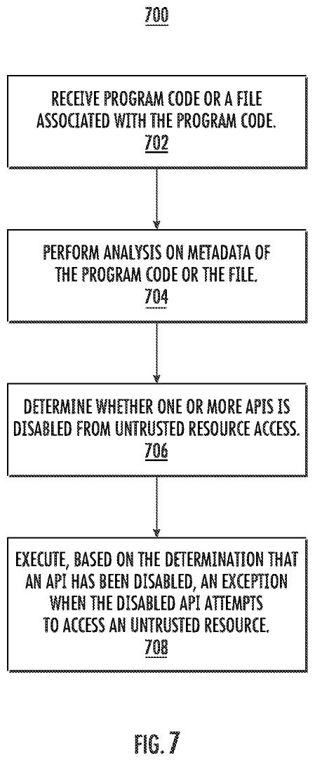

FIG. 7 illustrates an example flow diagram 700 according to embodiments. It may be understood that one or more of the blocks shown in flow diagram 700 may be performed by at least one processor executing secure instructions in a protected region of memory, e.g., a hardware trusted execution environment, such as an SGX enclave. The component performing the features of the blocks, as described above, may be a managed runtime system that may include one or more language-based virtual machines. It may further be understood that the blocks are not required to be arranged in a specific order and also not required to be performed sequentially (but may be performed simultaneously or near simultaneously).

In block 702, program code or a file associated with the program code may be received. The program code may be written in a managed runtime language, such as Java. The file associated with the program code may be a configuration file. The program code or the configuration file may include metadata that may have been inserted, inputted, or written by a developer. The metadata may include information that indicates one or more security requirements, as described above.

In block 704, analysis may be performed on the metadata of the program code or the file. For example, an annotation processor, e.g., a parser, may parse the metadata. In block 706, a determination may be made as to whether one or more application programming interfaces (APIs) is disabled from accessing untrusted resources. The one or more APIs may be provided or defined in the operating system library or libraries residing in the trusted execution environment. The APIs may be configured to access external resources, such as untrusted data, untrusted classes, functions, etc. The determination in block 706 may be performed by the parser, in some examples.

In block 708, when a determination is made that an API has been disabled, an exception may be executed when that API is attempted to be used to access the untrusted resource. The exception may be output by an exception handler. Moreover, a security enforcer may verify whether the API has indeed been disabled. If the API has not been disabled, however, the API may access the untrusted resource. Once access, that API may be dumped, where the dumping-related data can be tracked by the developer, for example, to develop one or more configuration files.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodology, but one of ordinary skill in the art may recognize that many further combinations and permutations are possible. Accordingly, the novel architecture is intended to embrace all such alterations, modifications and variations that fall within the spirit and scope of the appended claims.

The disclosure now turns to a number of illustrative examples.

Example 1. An apparatus, comprising: memory, the memory having at least one secure region; and processing circuitry, coupled to the memory, operable to execute a set of secure executable instructions in the at least one secure region of the memory, that when executed, causes the processing circuitry to: receive program code or a file associated with the program code, wherein the program code or the file includes metadata; perform analysis on the metadata of the received program code or file; determine whether one or more application programming interfaces (APIs) is disabled from untrusted resource access; and execute, based on the determination that an API has been disabled, an exception when the disabled API attempts to access an untrusted resource.

Example 2. The apparatus of example 1, wherein the program code is written in a runtime-based programming language and wherein the file is a configuration file.

Example 3. The apparatus of example 2, wherein the metadata is written, input, or embedded in the program code or the configuration file by a developer and the metadata is related to one or more security requirements.

Example 4. The apparatus of example 1, wherein the processing circuitry is caused to parse the metadata to perform the analysis.

Example 5. The apparatus of example 1, wherein the at least one secure region of the memory further includes one or more libraries configured to provide the one or more APIs.

Example 6. The apparatus of example 1, wherein the processing circuitry is caused to verify whether an API is disabled prior to executing the exception.

Example 7. The apparatus of example 1, wherein the processing circuitry is caused to allow, based on the determination that an API has not been disabled, the API to access the untrusted resource.

Example 8. The apparatus of example 1, wherein the untrusted resource includes one or more of the following: (i) a network input/output (I/O), (ii) a file system, and (iii) a system call.

Example 9. The apparatus of example 1, wherein the processing circuitry is caused to run the program code, in entirety, without refracting the program code.

Example 10. The apparatus of example 1, wherein the at least one secure region of the memory creates a hardware trusted execution environment (TEE).

Example 11. The apparatus of example 10, wherein the TEE includes at least a language-based virtual machine.

Example 12. The apparatus of example 1, wherein the processing circuitry is caused to create one or more security domains in the at least one secure region of the memory.

Example 13. The apparatus of example 12, wherein the one or more security domains is configured to isolate and run different parts of the program code based on one or more security requirements.

Example 14. The apparatus of example 13, wherein the processing circuitry is caused to: generate at least one protection key; and attach the at least one protection key to each of the one or more security domains.

Example 15. The apparatus of example 14, wherein the one or more security domains includes a first security domain and a second security domain.

Example 16. The apparatus of example 15, wherein the at least one protection key includes a first protection key and a second protection key.

Example 17. The apparatus of example 16, wherein the first protection key is attached to the first security domain and the second protection key is attached to the second security domain.

Example 18. The apparatus of example 17, wherein the processing circuitry is caused to: receive the message from the first security domain; decrypt the message using the first protection key; confirm that the second security domain is a correct recipient of the message based on the decrypted message; encrypt the message using the second protection key; and send the message to the second security domain.

Example 19. The apparatus of example 1, wherein the processing circuitry is caused to dump each of the one or more APIs that is not disabled and invoked to access the untrusted resource.

Example 20. A system comprising the apparatus of any one of examples 1 to 19.

Example 21. A method, comprising: receiving program code or a file associated with the program code, wherein the program code or the file includes metadata; performing analysis on the metadata of the received program code or file; determining whether one or more application programming interfaces (APIs) is disabled from untrusted resource access; and executing, based on the determination that an API has been disabled, an exception when the disabled API attempts to access an untrusted resource.

Example 22. The method of example 21, wherein the program code is written in a runtime-based programming language and wherein the file is a configuration file.

Example 23. The method of example 22, wherein the metadata is written, input, or embedded in the program code or the configuration file by a developer and the metadata is related to one or more security requirements.

Example 24. The method of example 21, wherein the processing circuitry is caused to parse the metadata to perform the analysis.

Example 25. The method of example 21, wherein the at least one secure region of the memory further includes one or more libraries configured to provide the one or more APIs.

Example 26. The method of example 21, wherein the processing circuitry is caused to verify whether an API is disabled prior to executing the exception.

Example 27. The method of example 21, The apparatus of example 1, wherein the processing circuitry is caused to allow, based on the determination that an API has not been disabled, the API to access the untrusted resource.

Example 28. The method of example 21, wherein the untrusted resource includes one or more of the following: (i) a network input/output (I/O), (ii) a file system, and (iii) a system call.

Example 29. The method of example 21, wherein the processing circuitry is caused to run the program code, in entirety, without refracting the program code.

Example 30. The method of example 21, wherein the at least one secure region of the memory creates a hardware trusted execution environment (TEE).

Example 31. The method of example 30, wherein the TEE includes at least a language-based virtual machine.

Example 32. The method of example 21, wherein the processing circuitry is caused to create one or more security domains in the at least one secure region of the memory.

Example 33. The method of example 32, wherein the one or more security domains is configured to isolate and run different parts of the program code based on one or more security requirements.

Example 34. The method of example 33, wherein the processing circuitry is caused to: generate at least one protection key; and attach the at least one protection key to each of the one or more security domains.

Example 35. The method of example 34, wherein the one or more security domains includes a first security domain and a second security domain.

Example 36. The method of example 35, wherein the at least one protection key includes a first protection key and a second protection key.

Example 37. The method of example 36, wherein the first protection key is attached to the first security domain and the second protection key is attached to the second security domain.

Example 38. The method of example 37, wherein the processing circuitry is caused to: receive the message from the first security domain; decrypt the message using the first protection key; confirm that the second security domain is a correct recipient of the message based on the decrypted message; encrypt the message using the second protection key; and send the message to the second security domain.

Example 39. The method of example 21, wherein the processing circuitry is caused to dump each of the one or more APIs that is not disabled and invoked to access the untrusted resource.

Example 40. A system comprising: one or more computing devices, wherein the one or more computing devices comprises: memory, the memory having at least one secure region; and processing circuitry, coupled to the memory, operable to execute a set of secure executable instructions in the at least one secure region of the memory, that when executed, causes the processing circuitry to: receive program code or a file associated with the program code, wherein the program code or the file includes metadata; perform analysis on the metadata of the received program code or file; determine whether one or more application programming interfaces (APIs) is disabled from untrusted resource access; and (i) execute, based on the determination that an API has been disabled, an exception when the disabled API attempts to access an untrusted resource or (ii) allow, based on the determination that the API has not been disabled, the API to access the untrusted resource.

Example 41. The system of example 40, wherein the untrusted resource includes one or more of the following: (i) a network input/output (I/O), (ii) a file system, and (iii) a system call.

Example 42. The system of example 40, wherein the processing circuitry is caused to run the program code, in entirety, without refracting the program code.

Example 43. The system of example 40, wherein the at least one secure region of the memory creates a hardware trusted execution environment (TEE) and wherein the TEE includes at least a language-based virtual machine.

Example 44. At least one machine-readable storage medium comprising at least one secure region storing instructions that when executed by at least one processor, causes the at least one processor to: receive program code or a file associated with the program code, wherein the program code or the file includes metadata; perform analysis on the metadata of the received program code or file; determine whether one or more application programming interfaces (APIs) is disabled from untrusted resource access; and execute, based on the determination that an API has been disabled, an exception when the disabled API attempts to access an untrusted resource.

Example 45. The at least one machine-readable storage medium of example 44, wherein the at least one processor is caused to allow, based on the determination that an API has not been disabled, the API to access the untrusted resource.

Example 46. The at least one machine-readable storage medium of example 44, wherein the untrusted resource includes one or more of the following: (i) a network input/output (I/O), (ii) a file system, and (iii) a system call.

Example 47. The at least one machine-readable storage medium of example 44, wherein the at least one processor is caused to run the program code, in entirety, without refracting the program code.

Example 48. The at least one machine-readable storage medium of example 44, wherein the at least one secure region of the at least one machine-readable storage medium creates a hardware trusted execution environment (TEE) and wherein the TEE includes at least a language-based virtual machine.

Example 49. An apparatus comprising means to perform the method of any one of examples 21 to 39.

Example 50. A system comprising means to perform the method of any one of examples 21 to 39.

Example 51. At least one machine-readable storage medium comprising means to perform the method of any one of the examples 21 to 39.

Example 52. An apparatus comprising the at least one machine-readable storage medium of any one of examples 44 to 48.

Example 53. A system comprising the at least one machine-readable storage medium of any one of examples 44 to 48.

1-25. (canceled)

26. An apparatus, comprising:
memory, the memory having at least one secure region; and
processing circuitry, coupled to the memory, operable to execute a set of secure executable instructions in the at least one secure region of the memory, which when executed causes the processing circuitry to:
receive program code or a file associated with the program code, wherein the program code or the file includes metadata;
perform analysis on the metadata of the received program code or file;
determine whether one or more application programming interfaces (APIs) is disabled from untrusted resource access; and
execute, based on the determination that an API has been disabled, an exception when the disabled API attempts to access an untrusted resource.

27. The apparatus of claim 26, wherein the program code is written in a runtime-based programming language and wherein the file is a configuration file.

28. The apparatus of claim 27, wherein the metadata is written, input, or embedded in the program code or the configuration file by a developer and the metadata is related to one or more security requirements.

29. The apparatus of claim 26, wherein the processing circuitry is caused to parse the metadata to perform the analysis.

30. The apparatus of claim 26, wherein the at least one secure region of the memory further includes one or more libraries configured to provide the one or more APIs and wherein the processing circuitry is caused to verify whether an API is disabled prior to executing the exception.

31. The apparatus of claim 30, wherein the processing circuitry is caused to dump each of the one or more APIs that is not disabled and invoked to access the untrusted resource.

32. The apparatus of claim 26, wherein the processing circuitry is caused to allow, based on the determination that an API has not been disabled, the API to access the untrusted resource.

33. The apparatus of claim 26, wherein the at least one secure region of the memory creates a hardware trusted execution environment (TEE) and wherein the TEE includes at least a language-based virtual machine.

34. The apparatus of claim 26, wherein the processing circuitry is caused to:
create one or more security domains in the at least one secure region of the memory, wherein the one or more security domains is configured to isolate and run different parts of the program code based on one or more security requirements;
generate at least one protection key;
attach the at least one protection key to each of the one or more security domains, wherein the one or more security domains includes a first security domain and a second security domain, wherein the at least one protection key includes a first protection key and a second protection key, and wherein the first protection key is attached to the first security domain and the second protection key is attached to the second security domain;
receive the message from the first security domain;
decrypt the message using the first protection key;
confirm that the second security domain is a correct recipient of the message based on the decrypted message;
encrypt the message using the second protection key; and
send the message to the second security domain.

35. A system comprising:
one or more computing devices, wherein the one or more computing devices comprises: memory, the memory having at least one secure region; and
processing circuitry, coupled to the memory, operable to execute a set of secure executable instructions in the at least one secure region of the memory, that when executed, causes the processing circuitry to:
receive program code or a file associated with the program code, wherein the program code or the file includes metadata;
perform analysis on the metadata of the received program code or file;
determine whether one or more application programming interfaces (APIs) is disabled from untrusted resource access; and
(i) execute, based on the determination that an API has been disabled, an exception when the disabled API attempts to access an untrusted resource or (ii) allow, based on the determination that the API has not been disabled, the API to access the untrusted resource.

36. The system of claim 35, wherein the untrusted resource includes one or more of the following: (i) a network input/output (I/O), (ii) a file system, and (iii) a system call.

37. The system of claim 35, wherein the processing circuitry is caused to run the program code, in entirety, without refracting the program code.

38. The system of claim 35, wherein the at least one secure region of the memory creates a hardware trusted execution environment (TEE) and wherein the TEE includes at least a language-based virtual machine.

39. The system of claim 35, wherein the metadata is written, input, or embedded in the program code or the configuration file by a developer and the metadata is related to one or more security requirements.

40. The system of claim 35, wherein the processing circuitry is caused to parse the metadata to perform the analysis.

41. The system of claim 35, wherein the at least one secure region of the memory further includes one or more libraries configured to provide the one or more APIs and wherein the processing circuitry is caused to verify whether an API is disabled prior to executing the exception.

42. The system of claim 41, wherein the processing circuitry is caused to dump each of the one or more APIs that is not disabled and invoked to access the untrusted resource.

43. The system of claim 35, wherein the processing circuitry is caused to:
create one or more security domains in the at least one secure region of the memory, wherein the one or more security domains is configured to isolate and run different parts of the program code based on one or more security requirements;
generate at least one protection key;
attach the at least one protection key to each of the one or more security domains, wherein the one or more security domains includes a first security domain and a second security domain, wherein the at least one protection key includes a first protection key and a second protection key, and wherein the first protection key is attached to the first security domain and the second protection key is attached to the second security domain;
receive the message from the first security domain;
decrypt the message using the first protection key;
confirm that the second security domain is a correct recipient of the message based on the decrypted message;
encrypt the message using the second protection key; and
send the message to the second security domain.

44. An apparatus, comprising:
means for receiving program code or a file associated with the program code, wherein the program code or the file includes metadata;
means for performing analysis on the metadata of the received program code or file;
means for determining whether one or more application programming interfaces (APIs) is disabled from untrusted resource access; and
means for executing, based on the determination that an API has been disabled, an exception when the disabled API attempts to access an untrusted resource.

45. The apparatus of claim 44, wherein the program code is written in a runtime-based programming language and wherein the file is a configuration file and wherein the metadata is written, input, or embedded in the program code or the configuration file by a developer and the metadata is related to one or more security requirements.

46. The apparatus of claim 44, comprising means for parsing the metadata to perform the analysis.

47. The apparatus of claim 44, wherein the at least one secure region of the memory further includes one or more libraries configured to provide the API.

48. The apparatus of claim 47, comprising means for verifying whether the API is disabled prior to executing the exception.

49. The apparatus of claim 44, comprising means for allowing, based on the determination that an API has not been disabled, the API to access the untrusted resource.

50. The apparatus of claim 44, wherein the untrusted resource includes one or more of the following: (i) a network input/output (I/O), (ii) a file system, and (iii) a system call.
